(19) United States
(12) Patent Application Publication
(10) Pub. No.: US 2026/0360691 A1
(43) Pub. Date: Nov. 12, 2026

(54) AN APPARATUS AND A METHOD FOR MANUFACTURING SLABS FROM CATHODE ACTIVE MATERIAL FOR RECHARGEABLE BATTERIES

(71) Applicant: SACMI COOPERATIVA MECCANICI IMOLASOCIETA'COOPERATIVA, Imola (Bologna) (IT)

(72) Inventors: Davide FOSCHI, Imola (Bologna) (IT); Giovanni CASALINI, Faenza (RAVENNA) (IT)

(21) Appl. No.: 19/123,314

(22) PCT Filed: Oct. 23, 2023
(86) PCT No.: PCT/IB2023/060668

§ 371 Date: Apr. 22, 2025

(30) Foreign Application Priority Data
Oct. 24, 2022 (IT) 102022000021891

(51) Int. Cl. H01M 4/04

(52) U.S. Cl. CPC H01M 4/0433

(57) ABSTRACT

Described is an apparatus (1) for manufacturing slabs (2) from powdery raw material.

The apparatus (1) includes: a lower die (3), defining a moulding cavity (4); an upper die (6) provided with an upper punch (601). The upper die (6) and the lower die (3) are movable relative to one another along a vertical direction (V) between an open position and a pressing position. The upper die (6) and the lower die (3) are also displaceable to a pre-pressing position where the moulding cavity (4) is closed by the upper punch (601) but is in air communication with a surrounding air volume. The apparatus (1) also includes a vacuum system for sucking air from the moulding cavity (4) when in the pre-pressing position and to keep a negative pressure inside the moulding cavity when in the pressing position.

### TECHNICAL FIELD

This invention relates to an apparatus and a method for manufacturing slabs from cathode active material for rechargeable batteries.

### BACKGROUND ART

Battery production is growing at an ever increasing rate under the impetus of the increasing demand for batteries in many fields.

Generally speaking, batteries fall into two broad categories: primary batteries, that is, batteries which cannot be recharged and are discarded at the end of their life cycle; and secondary batteries, that is, rechargeable batteries.

Rechargeable batteries include a set of electrodes, integrated in a can, for charging and discharging the electrical energy. Typically, the set of electrodes has a layer of anode material, a separator and a layer of cathode material which are rolled up or stacked to form a single body which is inserted into the can to form the battery cell. In addition, the battery cell is filled with electrolyte to carry positively charged lithium ions from the anode to the cathode, and vice versa, through the separator.

Of the different types of secondary batteries, lithium-ion batteries are currently the most popular worldwide, thanks to their high capacity and low self-discharge. In addition, cathode active materials are one of the most important components for the manufacture of lithium-ion batteries in that they determine the efficiency, reliability, costs, life and size of the batteries, hence their applications.

More specifically, cathode active materials are high purity chemicals. More specifically, a cathode active material undergoes a calcining process (a high temperature treatment) to remove impurities and volatile substances.

Cathode materials are typically constituted by cobalt, nickel and manganese in the crystalline structure, forming a multi-metal oxide material to which lithium is added to form a powdery mixture. During the calcining process, the powdery mixture is placed in containers, such as saggars, and usually fired in a kiln.

This method has some disadvantages, however. For example, in this method, the efficiency of the calcining process is low in that the heat and mass transfer coefficients are low because the powdery mixture is kept inside saggars and thus, the mixture has to remain in the kiln for an extended length of time, making the calcining process longer. Furthermore, the time needed to cool the saggar when it comes out of the kiln further increases process down times. Moreover, on account of the continual heating and cooling, the saggars usually have to be replaced after just a few weeks' use, thus increasing the cost of the process.

There is therefore a need to perform the calcining process without using any container so as to increase the efficiency of the process.

In this context, patent document JP2019175697A provides a method for manufacturing the cathode active material. More specifically, that document describes a method in which a moulded object is obtained by pressing powdery cathode active material (that is, in powder form); the moulded object then undergoes a calcining process. There is therefore a need to provide an apparatus and a method for manufacturing slabs from powdery raw material. In this context, patent document U.S. Pat. No. 3,657,917A provides a method and a system for obtaining high-quality moulded objects by compressing the powdery raw material. In this solution, the powdery material is placed in a die cavity which is then evacuated of gas and the powdery material is pre-compressed by a dual piston hammer assembly. In addition, the piston mass is impacted at high speed to apply a high-energy impulse through a ram die to strongly bond the particles of powdery material together under a hard vacuum, thus making an article precisely conforming to the die configuration.

Furthermore, patent document US2011113924A1 discloses a device and method for producing slabs from a powder, in particular from silicon. In particular, in this document the powder is fed to a feeding device, to transfer the powder to be compacted from a loading position to a cavity where the powder is compacted. The cavity is delimited laterally by a press bed and from below by a lower die and forms a molding chamber. On the inner side facing the molding chamber, the press bed has a filter insert, made of ceramic material, permeable to gases and an evacuation mechanism is coupled to the filter insert. Furthermore, an upper mold having a punch is provided and the molding chamber is closed airtight by the punch at its upper end. In particular, the upper mold is vertically movable. The molding chamber is then loaded with vacuum via the evacuation mechanism; the pressure in the mold chamber is thus reduced. Pressure on the upper die with the punch is then created by a pressure-producing mechanism to axially compact the powder in the mold chamber. In particular, the upper mold is guided downwards along the longitudinal axis until the punch air-tightly closes the mold chamber at the upper end.

The mold chamber is then charged with negative pressure via the evacuation mechanism.

In this field, however, there is an ever increasing need for an apparatus and method capable of more efficiently producing slabs from powdery cathode active material.

### DISCLOSURE OF THE INVENTION

The aim of this disclosure is to provide an apparatus and a method for manufacturing slabs from cathode active material for rechargeable batteries to overcome the above mentioned disadvantages of the prior art. This aim is fully achieved by the apparatus and method of this disclosure as characterized in the appended claims.

According to an aspect of it, this disclosure provides an apparatus for manufacturing slabs from powdery raw material. In an example, the powdery raw material is cathode active material for rechargeable batteries. The apparatus can also produce slabs from other materials. The term “powdery” is used to describe a material consisting of very fine, dry particles obtained by grinding, crushing or disintegration of a solid substance. In an example, the slabs are preferably rectangular. In other examples, the slabs may have other geometrical shapes. The apparatus comprises a lower die. The lower die defines a moulding cavity. It should be noted that the moulding cavity may have different geometrical shapes. The apparatus comprises a feeding device. The feeding device is configured to receive a charge of the powdery raw material and to feed the charge of the powdery raw material to the moulding cavity. The term “charge” is used to mean the measured quantity of raw material placed in the moulding cavity to make the slabs. The apparatus also comprises an upper die. The upper die is provided with an upper punch. The upper die is movable relative to the lower die along a vertical direction. More specifically, the upper die and the lower die are movable along the vertical direction between an open position and a pressing position. In the open position, the upper punch is spaced from the lower die to allow loading the charge into the moulding cavity. Also, in the pressing position, the upper punch is inserted into the moulding cavity to compress the charge to form the slab. In an example, the upper die and the lower die are also displaceable to a pre-pressing position. The pre-pressing position is vertically interposed between the open position and the pressing position. More specifically, in the pre-pressing position, the moulding cavity is closed by the upper punch to prevent the charge from moving out of the moulding cavity. In the pre-pressing position, however, the moulding cavity is in air communication with a surrounding air volume.

The apparatus may also comprise a sealing arrangement. The sealing arrangement is configured to keep the moulding cavity and the surrounding air volume airtight. More specifically, the sealing arrangement is configured to keep the moulding cavity and the surrounding air volume airtight, in the pre-pressing and pressing positions of the upper die and lower die.

According to an aspect of this description, the apparatus comprises a vacuum system. The vacuum system is configured to suck air from the moulding cavity. In an example, the vacuum system is configured to suck air from the moulding cavity in the pre-pressing position of the upper die and lower die. Further, the vacuum system is configured to keep a negative pressure inside the moulding cavity in the pressing position of the upper die. According to an aspect of this disclosure, therefore, the vacuum system removes air from the inside of the moulding cavity when the cavity is closed by the upper die but before the upper die compresses the powdery raw material inside the cavity. Further, the negative pressure inside the moulding cavity can be kept the whole time during compression to prevent air from entering the cavity during this time.

It should be noted that deaeration during compression of the powdery raw material inside the cavity is usually accomplished by pulsating movements of the upper punch. During the step of deaeration, the movement performed by the upper punch is a movement away from the powder and then towards and into contact with the powder, which was previously compressed (pulsation cycle). That way, the excess air in the die can be evacuated from the inside to the outside.

This deaerating process may take a long time because the moulding cavity usually requires several deaerating cycles. Using a vacuum system allows the air to be removed from the moulding cavity without having to perform the deaerating process described above. This makes it possible to obtain an apparatus that is faster and that can compress the powdery material in a particularly efficient manner, without losing material, hence obtaining higher quality slabs.

In an example, the lower die comprises a bottom wall. The lower die also has a lateral wall. More specifically, the lateral wall cooperates with the bottom wall to delimit the moulding cavity. In an example, the bottom wall and the lateral wall move relative to one another along the vertical direction. That way, the bottom wall and the lateral wall can be moved relative to one another so as to load the charge into the moulding cavity and/or to remove the formed slab from the moulding cavity.

In an example, the lower die comprises a lower punch. More specifically, the lower punch defines the bottom wall of the lower die. In an example, the lower die also includes a lower block. The lower block defines the lateral wall. The lower block also has a top surface. In an example, the top surface extends along a horizontal plane perpendicular to the vertical direction. The lower punch and the lower block are movable along the vertical direction relative to each other to be displaceable between an alignment position and an offset position. More specifically, in the alignment position, the bottom wall is flush with the top surface so that the bottom wall and the top surface lie in the same feeding plane. In the offset position, the bottom wall is placed below the top surface so as to define the moulding cavity.

In an example, the apparatus comprises a feeding surface. The feeding surface extends along the feeding plane. In an example, the feeding device defines a vertically oriented passage. Further, the feeding device may be movable in a working direction. The working direction is parallel to the feeding surface. In an example, the feeding device is also movable in sliding contact with the feeding surface. More specifically, the feeding device is movable between a loading position and an unloading position. In the loading position, the feeding device receives the charge of powdery raw material. In the unloading position, the passage is vertically aligned with the bottom wall. More specifically, in the unloading position, the passage is vertically aligned with the bottom wall so that the charge is contained in a volume delimited by the passage and the bottom wall.

Thus, according to an aspect of this disclosure, when the feeding device, as it moves, reaches the loading position, the charge is loaded, without stopping, and is transported into direct contact with the feeding surface. Furthermore, when the feeding device is in the unloading position, the bottom wall and the top surface are aligned and form the feeding plane; since the feeding surface extends along the feeding plane, the feeding device can move easily along the feeding plane to unload the charge onto the bottom wall. That way, feeding the charge to the moulding cavity is made more efficient.

The apparatus includes an outlet. In particular, the formed slabs are provided at the outlet. In an example, the apparatus comprises a pick-up device. The pick-up device is movable along the working direction. The pick-up device is movable between a pick-up position and a delivery position. In the pick-up position, the pick-up device grabs the formed slab. In the delivery position, the pick-up device delivers the slab to the outlet.

In an example, the apparatus comprises a carriage. The carriage is configured to move backwards and forwards along the working direction. In an example, the pick-up device and the feeding device are connected to the carriage. Further, the pick-up device is positioned upstream of the feeding device in the forward direction. More specifically, the forward direction is defined from the loading position towards the outlet of the apparatus. In an example, in the pick-up position of the pick-up device, the feeding device is placed in the loading position. In an example, in the delivery position of the pick-up device, the feeding device is placed in the unloading position. Thus, the process is made particularly fast in that the feeding device and the pick-up device move between two positions simultaneously, where, in the first position, the formed slabs are picked up while the feeding device feeds the charge and, in the second position, the formed slabs are delivered to the outlet while the moulding cavity is loaded and can proceed to form the next slab. In another example, the feeding device and the pick-up device are also displaceable to a third position, located downstream of the unloading position. More specifically, in the third position, both the feeding device and the pick-up device are downstream of the moulding cavity in the forward direction and are located at the outlet of the apparatus. In this example, the feeding device, during the movement in the backward direction (defined from the outlet to the loading position) skims the charge while the lower block and the lower punch are in the offset position so that the charge in the moulding cavity is levelled by the feeding device.

In an example, in the pick-up position of the pick-up device (FIG. 1), the bottom wall is configured to be moved upwards along the vertical direction V. Also in the pick-up position of the pick-up device, the lateral wall is configured to be displaced downwards along the vertical axis. When the pick-up device is in the pick-up position, the bottom wall may move upwards to the alignment position and, at the same time, the lateral wall moves downwards. This solution is particularly advantageous to remove the formed slab from the moulding cavity without damaging the slab.

In an example, the apparatus comprises a pair of sliding bars. In an example, the sliding bars extend longitudinally. The sliding bars are spaced from each other along a first horizontal axis. Each sliding bar has a first end and a second end. More specifically, the first horizontal axis is orthogonal to a second horizontal axis extending along the working direction. The carriage may be configured to slide on the sliding bars. More specifically, the carriage slides on the sliding bars backwards and forwards along the working direction. In an example, the apparatus comprises a plurality of longitudinal wheels. The longitudinal wheels are distributed on each of the sliding bars. The longitudinal wheels are distributed along the working direction. The longitudinal wheels are configured to support the weight of the carriage along the sliding bars. The longitudinal wheels allow the carriage to move backwards and forwards along the working direction. The apparatus may also comprise transversal wheels. The transversal wheels are placed on each sliding bar. The transversal wheels are arranged rotated by 90 degrees with respect to the longitudinal wheels. The transversal wheels are adapted to keep the carriage aligned with the working direction along which it moves. In an example, the longitudinal and transversal wheels are made from materials that do not risk contaminating the cathode material being processed in the press.

For example, the longitudinal wheels may be made from steel, preferably carburized steel. Steel is advantageous because it reduces the wear rate of the longitudinal wheels which must bear the weight of the sliding carriage.

As to the transversal wheels, these may be made, for example, from rubber, or they may be rubber coated, for example by a vulcanization process.

The transversal wheels may be placed at the first and the second end of each sliding bar.

In an example, the bottom wall is movable vertically relative to the lateral wall. The apparatus includes an inlet to receive the powdery raw material. In an example, the apparatus comprises a particle suction system. The particle suction system is configured to remove airborne particles. In an example, the particle suction system has a first hood and a second hood. In an example, the first and the second hood are connected to the upper die. More specifically, the first hood may be placed upstream of the moulding cavity in an advancing direction. The advancing direction is defined from the inlet towards the outlet. The first hood is configured to remove the airborne particles from the surroundings of the moulding cavity. Further, the second hood is placed downstream of the moulding cavity in the advancing direction. The second hood is configured to remove the airborne particles from the surroundings of the outlet.

In an example, the lower die includes a plurality of moulding cavities. The moulding cavities of the plurality of moulding cavities may be arranged to form an array of moulding cavities. Furthermore, the upper die may include a plurality of upper punches. More specifically, each upper punch is configured to cooperate with a corresponding moulding cavity to form a respective slab of a plurality of slabs. It is thus possible to increase the productivity of the apparatus.

In an example, the apparatus comprises a heating system. The heating system is connected to the lower die and to the upper die to keep them at a predetermined temperature.

Heating the dies allows easier removal of the formed slabs from the moulding cavities and, generally speaking, prevents the powdery raw material from sticking to the moulding cavity or to the upper punch.

In an example, the bottom wall, the lateral wall and the upper punch are made from stainless steel. According to an aspect of this disclosure, therefore, all the parts of the moulds that are in direct contact with the powdery raw material are made from a material that does not react with the powdery raw material; this solution prevents the powdery material from being contaminated in any way.

Furthermore, steel is able to withstand the pressure exerted by the powder (powdery raw material) pressed towards the lateral walls.

In an example, the upper punch has a first layer and a second layer. The lower punch may also have a first layer and a second layer. The second layer is in contact with the powdery raw material. The second layer is removably connected to the first layer. More specifically, the second layer of the upper punch and of the lower punch is made from stainless steel. It is therefore possible to make the upper punch and the lower punch in such a way that the part that comes into contact with the powdery raw material is made from stainless steel. Thus, the apparatus can be made more cost effective.

In one example, the step of sucking air from the molding cavity begins when the upper die and the lower die are in the pre-pressing position, and continues during the movement of the upper die downwards along the vertical direction between the pre-pressing position to a position where the upper punch is in contact with the powder inside the cavity.

### BRIEF DESCRIPTION OF DRAWINGS

These and other features will become more apparent from the following description of a preferred embodiment, illustrated by way of non-limiting example in the accompanying drawings, in which:

FIG. 1 shows an apparatus for manufacturing slabs from powdery cathode active material according to this disclosure, with the feeding device in the loading position;

FIG. 2 shows the pick-up position of the pick-up device;

FIG. 3 shows the apparatus with the pick-up device in the delivery position;

FIG. 4 shows the pre-pressing position of the lower die and of the upper die;

FIG. 5 shows the pressing position of the lower die and of the upper die;

FIGS. 6 and 8 show the lower die and the upper die;

FIG. 7 shows the apparatus in an axonometric view from a different angle;

FIG. 9 is a side view of the apparatus;

FIG. 10 shows scraping elements,

FIG. 11 shows details on the sliding bars,

FIG. 12 shows the hydraulic system,

FIGS. 13A and 13B show details of the vacuum system.

### DETAILED DESCRIPTION OF PREFERRED EMBODIMENTS OF THE INVENTION

With reference to the accompanying drawings, the numeral 1 denotes an apparatus for manufacturing slabs 2 from powdery raw material. In an example, the powdery raw material is cathode active material for rechargeable batteries. The apparatus for manufacturing slabs 2 from powdery raw material (that is, the apparatus 1) comprises a lower die 3. The lower die 3 defines a moulding cavity 4. The moulding cavity receives the powdery raw material to be compressed to form the slab. More specifically, the lower die 3 includes a bottom wall 301. The lower die 3 also includes a lateral wall 302. The lateral wall 302 cooperates with the bottom wall to delimit the moulding cavity 4. In an example, the moulding cavity is rectangular in shape. In this example, the lateral wall 302 includes four walls that surround the bottom wall 301. In an example, the lower die 3 includes a plurality of moulding cavities. The moulding cavities of the plurality of moulding cavities may be arranged to form an array of moulding cavities. Each moulding cavity has a respective bottom wall 301 and a lateral wall 302.

The bottom wall 301 and the lateral wall 302 move relative to one another along the vertical direction V. In an example, the bottom wall 301 is movable vertically relative to the lateral wall 302.

The lower die 3 may comprise a lower punch 303. More specifically, the lower punch 303 defines the bottom wall 301.

In an example, the lower punch 303 includes a first layer L1 and a second layer L2. The second layer is in contact with the powdery raw material.

In an example, the second layer is removably connected to the first layer.

In an example, the lower die 3 includes a plurality of magnets M. In this example, the first layer L1 of the lower punch 303 is magnetized. The first layer may therefore be connected to the lower punch 303 via magnets M. In an example, the first layer L1 is made from soft iron. In an example, the first layer L1 also has a plurality of through holes. The second layer L2 includes a plurality of blind holes. The first layer may be connected to the second layer by a plurality of screws which join the first layer to the second layer via the through holes and the blind holes. In an example, the second layer is made from stainless steel. Preferably, the second layer L2 of the lower punch 303 is made from high hardenability, martensitic stainless steel. The stainless steel may comprise carbon. The stainless steel may comprise silicon. The stainless steel may comprise manganese. The stainless steel may comprise chrome. The stainless steel may comprise vanadium. More specifically, the stainless steel has high polishability and resistance to corrosion and to thermal oxidation.

Moreover, the stainless steel may undergo one or more heat treatments.

In an example, the stainless steel is annealed to give it a hardness less than or equal to 240. Preferably, the stainless steel is annealed at 750 °C 800 °C. The stainless steel may be annealed under steady state conditions for at least 3 hours. The steel is then cooled. It may also undergo a process of relaxation. The relaxation process is performed after a machining process. The relaxation process is performed before a final heat treatment. During the relaxation process, the steel is heated to 600-650 °C. During the relaxation process, the steel is heated for two hours. There may also be a step of tempering the stainless steel. During the step of tempering, the steel is heated to 600-700 °C. The step of tempering also includes a step of austenitizing at 990-1040 °C. The steel is then cooled. In an example, the steel may be cooled in oil. The steel may undergo a thermal bath at 500-550 °C and then an oil bath, where the steel is cooled as a function of its shape and size. In an example, the hardness of the Steel after tempering is 52-56 HRC.

In an example, the second layer is thinner than the first layer. Thus, the part in direct contact with the powdery raw material is made from a steel as described above. It should be noted that connecting the second layer to the first layer as described above (by means of blind holes) creates a configuration in which no material other than the stainless steel comes into contact with the powdery raw material. As explained above, cathode active materials are very high value and must be very pure to obtain a high quality electrode. Thus, the powdery raw material must remain in contact only with materials that do not produce any unwanted reaction or contamination. Further, such a configuration makes it possible to use a minimum amount of said stainless steel to provide a thin layer (the second layer) which comes into contact with the raw material, thus increasing efficiency in terms of process costs.

Further, in an example, the lateral wall 302 is made in two layers. The first layer of the lateral wall 302 is made from said stainless steel. In an example, the first layer of the lateral wall is connected to the second layer of the lateral wall by a plurality of screws. In this example, both the second layer and the first layer of the lateral wall 302 include a plurality of through holes, through which the plurality of screws pass. In an example, the through holes of the lateral wall are made in a bottom part of the first and second layers of the lateral wall so that the through holes are at a height below the bottom wall along the vertical direction V. That way, the plurality of screws and through holes do not come into contact with the powdery raw material.

The lower die 3 may also include a lower block 304. The lower block 304 defines the lateral wall 302. The lower block also has a top surface 3041. The top surface 3041 extends along a horizontal plane perpendicular to the vertical direction V. In an example, the lower punch 303 and the lower block 304 are movable relative to each other along the vertical direction V. The lower punch 303 and the lower block 304 are movable along the vertical direction relative to each other to be displaceable between an alignment position and an offset position. In the alignment position, the bottom wall 301 is flush with the top surface 3041. More specifically, in the alignment position, the bottom wall 301 is flush with the top surface 3041 so that the bottom wall 301 and the top surface 3041 lie in the same feeding plane. Further, in the offset position, the bottom wall 301 is placed below the top surface 3041 so as to define the moulding cavity 4. In other words, in the offset position, the bottom wall 301 is placed at a lower height than the top surface 3041 along the vertical direction.

More specifically, the lower punch 303 is moved along the vertical direction V by an actuator. In an example, the actuator is a hydraulic system. The hydraulic system has a cylinder and a piston that runs in the cylinder along the vertical direction V. More specifically, the lower punch 303 is moved along the vertical direction by the piston.

The apparatus 1 also comprises an upper die 6. The upper die 6 is provided with an upper punch 601. In the case where the lower die 3 includes the plurality of moulding cavities, the upper die 6 includes a plurality of upper punches 601. More specifically, each upper punch is configured to cooperate with a corresponding moulding cavity 4 to form a respective slab 2 of a plurality of slabs 2. In an example, the upper punch 6 includes a first layer L1 and a second layer L2. In an example, the second layer L2 of the upper punch 601 is in contact with the powdery raw material.

In an example, the second layer L2 of the upper punch 601 is removably connected to the first layer.

In an example, the upper die 6 includes a plurality of magnets M. In this example, the first layer L1 of the upper punch 601 is magnetized. The first layer of the upper punch 601 may therefore be connected to the second layer of the upper punch 601 via the magnets M of the upper punch. In an example, the first layer L1 of the upper punch 601 is made from soft iron. In an example, the first layer L1 of the upper punch 601 also has a plurality of through holes. The second layer L2 of the upper punch 601 includes a plurality of blind holes. The first layer of the upper punch 601 may be connected to the second layer of the upper punch 601 by a plurality of screws which join the first layer of the upper punch 601 to the second layer of the upper punch 601 via the through holes and the blind holes. In an example, the second layer of the upper punch 601 is made from stainless steel. In an example, the second layer of the lower punch 303 and of the upper punch 601 is corrugated. Thus, in an example, a top surface and an underside surface of the slab 2 are corrugated.

The apparatus also comprises a feeding device 5. The feeding device is configured to receive a charge of the powdery raw material and to feed the charge of the powdery raw material to the moulding cavity 4. The feeding device receives the charge of powdery raw material from a hopper 13.

The upper die 6 is movable relative to the lower die 3 along the vertical direction V. More specifically, the upper die 6 is movable relative to the lower die along the vertical direction between an open position and a pressing position. In an example, the upper die 6 moves vertically to move between the open position and the pressing position. In another example, the upper die may remain stationary while the lower die moves between the open position and the pressing position. Alternatively, the lower die and the upper die both move together between the open position and the pressing position.

In the open position, the upper punch 601 is spaced from the lower die 3 to allow loading the charge into the moulding cavity 4. In the pressing position, the upper punch 601 is inserted into the moulding cavity 4 to compress the charge to form the slab 2. More specifically, in the pressing position, the upper punch 601 defines an upper wall of the moulding cavity 4. In an example, the upper die 6 and the lower die 3 are also displaceable to a pre-pressing position. The pre-pressing position is vertically interposed between the open position and the pressing position. More specifically, in the pre-pressing position, the moulding cavity 4 is closed by the upper punch 601 to prevent the charge from moving out of the moulding cavity 4. Further, the moulding cavity is in air communication with a surrounding air volume.

The apparatus 1 comprises a feeding surface 9. The feeding surface extends along the feeding plane. In an example, the feeding device 5 defines a passage 501. The passage 501 is oriented vertically. In an example, the feeding device 5 is movable in a working direction WD. The working direction is parallel to the feeding surface 9. In an example, the feeding device 5 is movable in sliding contact with the feeding surface 9. The feeding device is movable between a loading position and an unloading position.

In an example, the lower block 304 is stationary. The top surface 3041 is therefore stationary and horizontally aligned with the feeding surface. In an example, the lower block 304 has a stationary part and a movable part. More specifically, the stationary part is defined by the top surface 3041 and the movable part is defined by the lateral wall 302 of the lower die 3.

It should be noted that the block 304 may be stationary or movable. If the block 304 is movable, it moves synchronously with the top surface 3041 and with the wall 302 (which are integral or may be integral). The movement of the block 304 may help to extract the part from the moulding cavity. If the block 304 is stationary, extraction of the part is accomplished (only) by the upward movement of the lower punches 303.

The lateral wall 302 of the lower die may be movable along the vertical direction V. In an example, in the alignment position, the lateral wall is at the same height as the top surface so as to form the feeding plane together with the bottom wall.

In the loading position, the feeding device 5 receives the charge of powdery raw material. In the unloading position, the passage 501 is vertically aligned with the bottom wall 301 of the lower die 3. More specifically, in the unloading position, the passage is vertically aligned with the bottom wall so that the charge, in the unloading position, is contained in a volume delimited by the passage 501 and the bottom wall 301.

In an example, the feeding device 5 includes a plurality of blades 502 disposed horizontally, orthogonally to the working direction WD and spaced from each other. The blades are equidistant from each other. More specifically, when the feeding device moves between the loading position and the unloading position, the blades remain in sliding contact with the feeding surface 9. That way, the powdery raw material is transported evenly on the feeding surface 9. In an example, the blades 502 may be provided with a plurality of grooves. The grooves are made along the bottom of each blade where the blades are in sliding contact with the feeding surface 9. In the case where the lower die 3 includes the plurality of moulding cavities, the feeding device 5 is divided into different sections. Each section is defined by a plurality of bars which are spaced from each other and disposed orthogonally to the blades 502. The sections are separate from each other. Each section corresponds to a respective moulding cavity 4.

The apparatus 1 also includes a sealing arrangement 7. The sealing arrangement is configured to keep the moulding cavity and the surrounding air volume airtight, in the pre-pressing and pressing positions of the upper die and lower die. The sealing arrangement is connected to the upper die 6. More specifically, the sealing arrangement surrounds the upper die 601 to keep the moulding cavity and the surrounding air volume airtight, in the pre-pressing and pressing positions of the upper die and lower die. Also, when the upper die and the lower die are in the pre-pressing position, the sealing arrangement rests on the top surface 3041. Moreover, when the dies 3, 6 are in the pressing position, the sealing arrangement is compressed.

According to an aspect of this disclosure, the apparatus also comprises a vacuum system. The vacuum system sucks air from the moulding cavity 4. In an example, the vacuum system sucks air from the moulding cavity 4 in the pre-pressing position of the upper die and lower die. Alternatively, the vacuum system may operate when the dies are in other positions.

In particular, during the vacuum the air is sucked in both from above (upwards) and from below (downwards) of the cavity. Suction channels are provided in the lower die and in the upper die for sucking air from the molding cavity, so that air is sucked both from above and below the moulding cavity. In particular, the air that is sucked in from above is sucked in through upper channels placed between the lateral walls of the moulding cavity and the sealing arrangement (in the gap that separates the lateral walls and the sealing arrangements). The bottom wall is provided with suction holes that suck the air from below. In one example the lower die is provided with holes F which allow air to be sucked from under the cavity during suction. Furthermore, lower channels can be provided in the lower die, connected to the holes, so that the sucked air is guided into the channels and is sucked out of the holes. Furthermore, the upper die and the lower die are equipped with suction pipes 20, 21 through which suction takes place.

The vacuum system is also configured to keep a negative pressure inside the moulding cavity. In an example, the vacuum system is configured to keep a negative pressure inside the moulding cavity in the pressing position of the upper die and of the lower die. The vacuum system comprises a vacuum pump. The vacuum system comprises one or a plurality of vacuum pipes. In an example, the vacuum pipes include a first pipe VT1 and a second pipe VT2, connected to the upper die 6 and to the lower die 3, respectively.

The apparatus includes an inlet I. The inlet I is configured to receive the powdery raw material. The hopper 13 is located at the inlet I of the apparatus 1. The apparatus 1 comprises an outlet O. The formed slabs 2 are provided at the outlet. In an example, the apparatus 1 includes a pick-up device 11. The pick-up device 11 is movable along the working direction WD. The pick-up device 11 is movable between a pick-up position and a delivery position. In the pick-up position, the pick-up device grabs the formed slab 2. In the delivery position, the pick-up device 11 delivers the slab to the outlet O. In an example, the pick-up device includes a plurality of fingers 111 (or grippers). The fingers are spaced from each other to receive the slab. In this case, the lower die 3 includes a plurality of moulding cavities 4. The number of fingers corresponds to the number of moulding cavities, so that every pair of fingers grabs a slab 2.

In an example, the lateral wall 302 moves along the vertical direction to the pick-up position of the pick-up device. Thus, when the pick-up device 11 is in the pick-up position, the bottom wall moves upwards along the vertical direction to carry the slab to the height of the feeding surface 9, where the pick-up device receives the slab. In an example, the lateral wall moves downwards at the same time. In an example, the lateral wall moves downwards only.

The upper punch 601 is moved vertically upwards and downwards via a hydraulic system 19. The hydraulic system is different from the hydraulic system that moves the lower die.

The hydraulic system includes a 190 tank. The tank contains oil (activation oil). The hydraulic system includes an activation element 191. The activation element includes a stationary part 191A and a movable part 191B. The movable part of the activation element is vertically movable. The movable part of the activation element is vertically movable between an open position and a closed position. In the closed position the movable part is in proximity to the stationary part.

In the open position of the activation element the movable part is distanced from the stationary part and is placed at a lower height than the stationary part.

The activation element is placed inside the tank and is therefore surrounded with oil. The hydraulic system includes a first lowering conduit 192 and a first lifting conduit 193. The activation element is in communication with the first lifting conduit and the first lowering conduit.

In particular, oil passages are provided between the movable part and the stationary part. These oil passages are in communication with the first lifting conduit and the first lowering conduit and create closed oil chambers with variable volume between the movable part and the stationary part (these chambers are separated from the oil in the tank). The volume of said oil chambers changes with the movement of the movable part. In particular, the volume increases when the movable part moves towards the open position of the activation element and the distance between the movable part and the stationary part increases. When oil is supplied to the first lowering conduit, the movable part of the actuating element is moved vertically towards the open position of the actuating element (and the volume of the oil chamber connected to the first lowering conduit increases). The movable part moves downwards until it reaches a predetermined end position. When the movable part is placed in the open position (end position), even if the oil supply to the first lowering conduit continues, the movable part is no longer moved downwards. When oil is fed to the first lifting conduit, the movable part moves vertically upwards towards the closed position. The hydraulic system also includes a displacement element 194. The displacement element is connected to the upper punch 601 on one side and to the tank on another side. In particular, the displacement element is in oil communication with the tank. When the movable part is in the open position of the activation element, an oil chamber is created between the displacement element and the movable part at a lower portion of the tank. Therefore, in the open position of the activation element of the movable part, the displacement element is in oil communication only with a part of the tank, closed between the mobile part and the displacement element. Furthermore, the displacement element is connected to a second lowering conduit 195 and a second lifting conduit 196. In particular, the displacement element includes an upper part 194A and a lower part 194B.

The upper part of the displacement element is in oil communication with the tank, and is connected to the second lowering conduit. The lower part of the displacement element is attached to the upper punch, and is in communication with the second lifting conduit. The upper and lower parts are joined together. In particular, oil communication is provided between the lower part and the upper part of the displacement element. There is a capillary passage of oil C between the lower part and the upper part.

When oil is supplied to the second lowering conduit (and the movable part is in the open position) the oil pushes the upper part of the displacement element and therefore the displacement element and consequently the upper punch move downwards (therefore the punch moves towards the pressure position). In one example, the tank is also moved vertically. When the oil is fed to the second lifting conduit, the movable part is in the closed position and therefore the displacement element is in communication with the oil with the entire tank. In this case the oil enters the capillary passage C and pushes the portion of the displacement element between the lower part and the upper part and lifts the displacement element and consequently the upper punch.

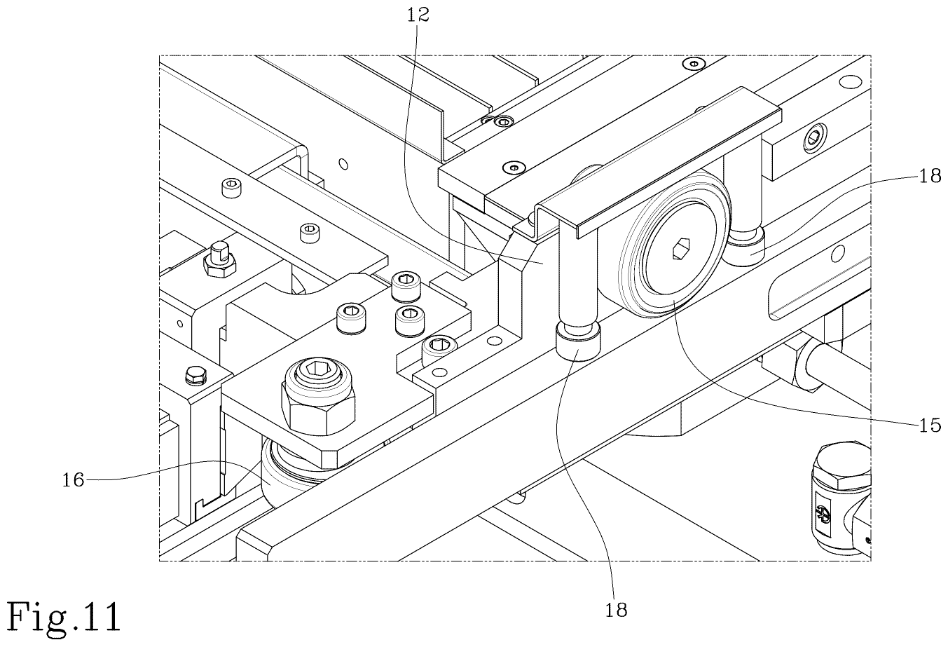

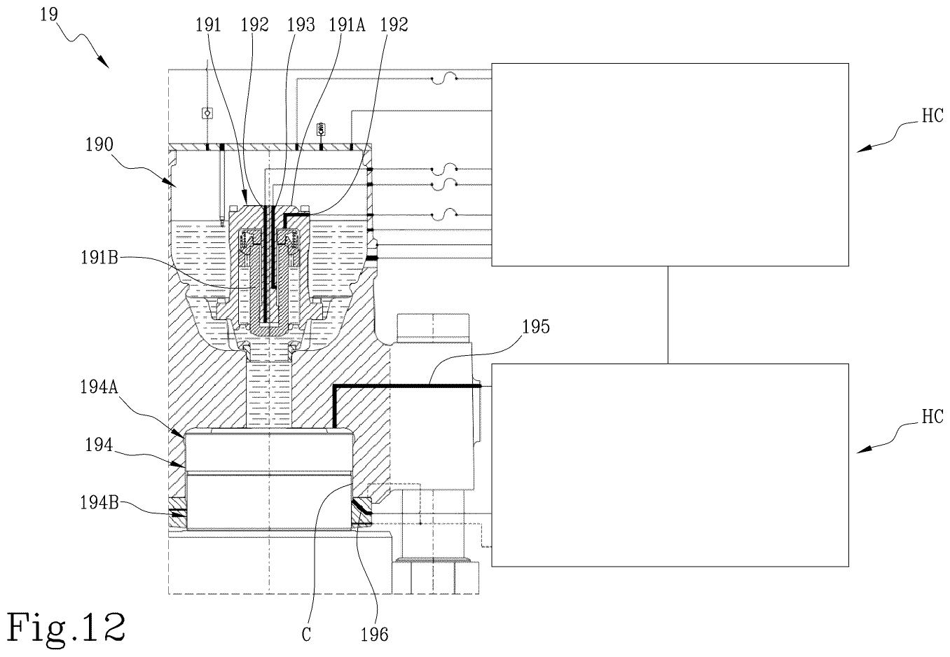

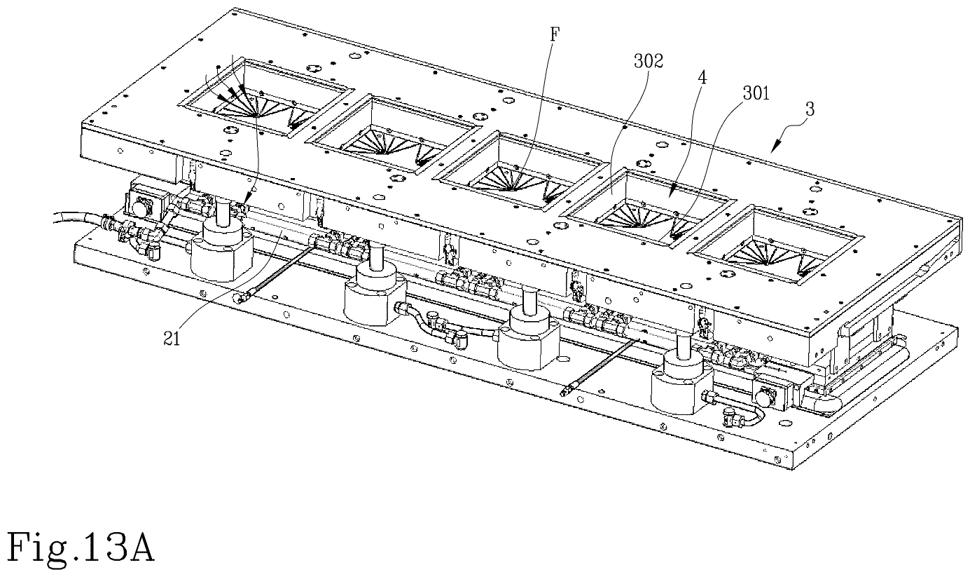

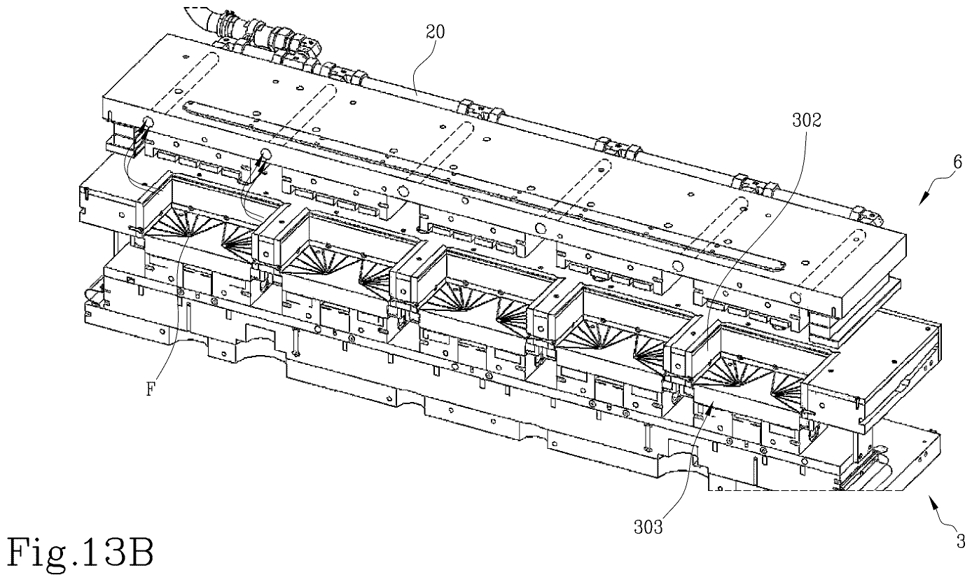

The hydraulic system also includes an hydraulic circuit HC in communication with the hydraulic system which allows oil to circulate in the system. To avoid complicating FIG. 11, the hydraulic circuit is illustrated with two blocks in this figure. This circuit includes valves (for example solenoid valves) and other elements known in hydraulic circuits.

Furthermore, the apparatus includes a control unit. The control unit automatically manages the hydraulic system.

It may be provided that when the top punch is moved downwards the movement of the top punch is regulated via the hydraulic system, for example by adjusting the a throttling valve, between a position where the upper punch begins to interact with the lateral walls to close the cavity and be placed in the pre-pressing position (where the powder cannot come out of the cavity but the air can), up to the position where the upper punch is in contact with the powder (but no pressure is exerted yet).

Preferably, the suction (via the vacuum system) is activated when the cavity is closed by the upper punch. Therefore, when the suction is activated the dust does not come out of the cavity. It can be expected that the suction continues even after the cavity is closed by the upper punch (the pre-pressing production). Therefore, the suction is activated when the pre-pressing position of the lower mold and the upper mold is reached. In one example, when the lower and upper die are placed in the pre-press position the vertical movement of the upper die (and the punch) is stopped and the vacuum is activated while the lower and upper die are in the pre-press position. It can be provided that when a predetermined threshold of depressure is reached the vacuum is deactivated. The vertical movement of the upper die downwards is then continued until the upper die and lower die are in the pressing position. In another example, it is envisaged that the suction continues even during the movement of the upper die from the pre-pressing position to the pressing position. Therefore, in that example, the suction begins when the lower and upper die are in the pre-pressing position and continues as the upper die moves towards the pressing position until it reaches a point where the upper punch comes into contact with the powder but it does not press the powder inside the cavity.

Suction can be managed in feedback control. In particular, it can be provided that a vacuum signal is obtained which represents a cavity suction value; when a predetermined (desired) depressure threshold is reached, vacuum is deactivated.

the hydraulic system can be configured to generate a damping effect for the upper die during vertical downward movement.

It can be provided that, when the suction is continued while the upper punch is in contact with the powder inside the cavity (but still the pressure is not exerted), the hydraulic system continues to generate the damping effect to lighten the upper die which has a notable weight and could exert excessive pressure on the powder inside the cavity.

In particular, since the closure of the cavity begins by the upper punch the vacuum can begin, while the upper punch goes downwards, the suction continues; at a certain point, the upper punch comes into contact with the powder and can remain in that situation (without pressing the dust) and the vacuuming can continue in that configuration. In such a configuration the upper punch is held (via the hydraulic system, for example, via a regulating valve) in an equilibrium situation.

After the suction is finished, the upper die and the upper punch which is in contact with the powder are pressed down to compress the powder.

The pressing (compression) of the powder can be carried out in feedback control, based on a set-point value of pressure exerted on the powder and/or the position of the upper punch. Once compression is complete, the upper die (and upper punch) is moved upward to the open position. In particular, the upper die is moved upwards and downwards via this hydraulic system. Two different branches (including separate ducts and valves) may be provided in the hydraulic circuit for moving the upper die between the open position, the pre-pressing position and the position where the upper die is in contact with the powder inside the cavity but the powder is not compressed by the upper punch, and for pressing the upper die downward while in contact with powder to compress the powder.

The apparatus can include an interface that allows the operator to adjust a series of working parameters, to adapt the pressing process to the material and product to be molded. For example, a database can be provided that includes the adjustment parameters identified and set by the operator for different types of materials.

In an example, the apparatus 1 comprises a carriage 12. The carriage 12 is configured to move backwards and forwards along the working direction WD. In an example, the pick-up device 11 and the feeding device 5 are connected to the carriage 12. In an example, the pick-up device 11 is positioned upstream of the feeding device 5 in the forward direction. The forward direction is defined from the loading position towards the outlet O. Furthermore, in the pick-up position of the pick-up device 11, the feeding device 5 is placed in the loading position. In the delivery position of the pick-up device, the feeding device 5 is placed in the unloading position. In an example, the carriage runs on the feeding surface 9.

In an example, the apparatus 1 includes a pair of sliding bars 14. The sliding bars 14 extend longitudinally. The sliding bars 14 are spaced from each other along a first horizontal axis H1. Further, each sliding bar has a first end 14A and a second end 14B. The first horizontal axis is orthogonal to a second horizontal axis H2. The second horizontal axis H2 extends along the working direction WD. The carriage 12 is configured to run on the sliding bars backwards and forwards along the working direction.

The apparatus includes a plurality of longitudinal bearings. The apparatus also includes a plurality of longitudinal wheels 15. The longitudinal wheels are distributed on each of the sliding bars 14 along the working direction WD. The longitudinal wheels are configured to support the weight of the carriage 12 along the sliding bars. The longitudinal bearings rotationally support the respective longitudinal wheels 15, associated with the carriage 12 to allow the carriage 14 to run along the sliding bars 14. In an example, the apparatus includes a pair of scraper elements 18, located along the sliding direction of the wheel, upstream and downstream of the wheel with respect to the direction of movement. The scraper elements 18 are in sliding contact with the sliding bar 14 which the respective wheel runs on; the scraper elements 18 have the function of keeping clean the surface of the sliding bar 14 which the wheel rolls on. Preferably, the scraper elements, or at least the parts of them which slide on the sliding bar 14, are made from plastic. This has the advantage of preventing contamination.

The apparatus also includes transversal wheels 16. The apparatus also includes a plurality of transversal bearings. The transversal bearings rotationally support corresponding transversal wheels 16 whose function is to keep the carriage 12 aligned with the working direction WD along which it moves. The transversal wheels are placed, for example, at the first and the second end 14A, 14B of each sliding bar 14. The transversal wheels are arranged rotated by 90 degrees with respect to the longitudinal wheels 15.

Preferably, the transversal wheels 16 are made from (or coated with) vulcanized rubber, and the longitudinal wheels 15 are made from (carburized) steel. This has the advantage of preventing the generation of dust or particles that could contaminate the product to be processed (that is the cathode powders to be compacted in the press); the carburized steel also ensures a long working life, despite the fact that the longitudinal wheels support the weight of the carriage.

In this case, too, one or more (or all) of the transversal wheels 16 are provided with corresponding pairs of scraper elements 18, as described above for the longitudinal wheels. The scrapers of the transversal wheels have the function of keeping clean the guides on which the transversal wheels roll. In this case, too, therefore, the fact that the scraper elements, or at least the parts of them which slide on the respective guides, are made preferably from plastic, has the advantage of preventing the production of possible contaminants.

In an example, in the pick-up position of the pick-up device 11, the bottom wall 301 moves upwards along the vertical axis V. Moreover, when the pick-up device 11 reaches the pick-up position, the lateral wall 302 has moved downwards along the vertical axis V.

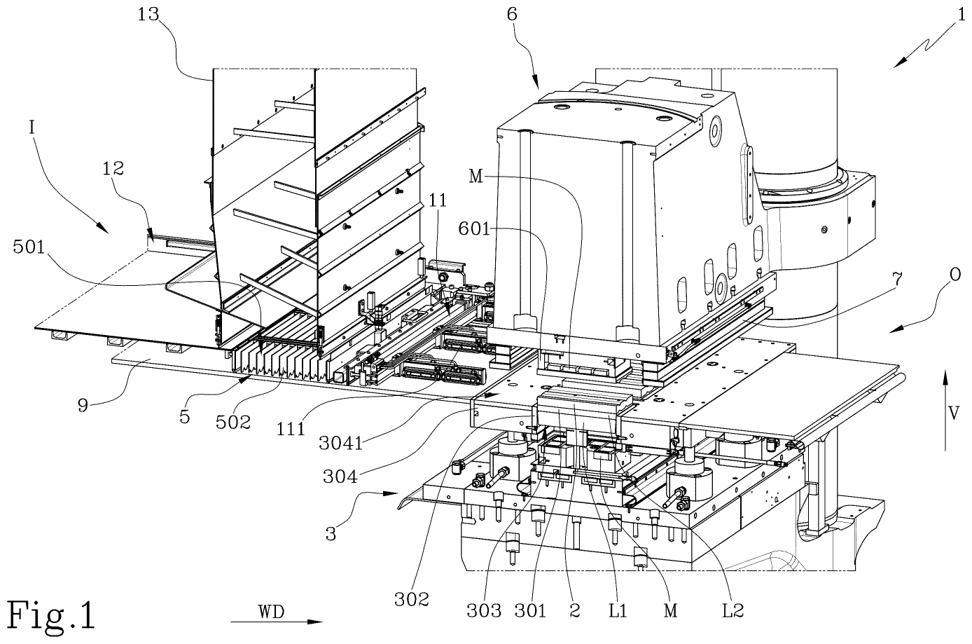

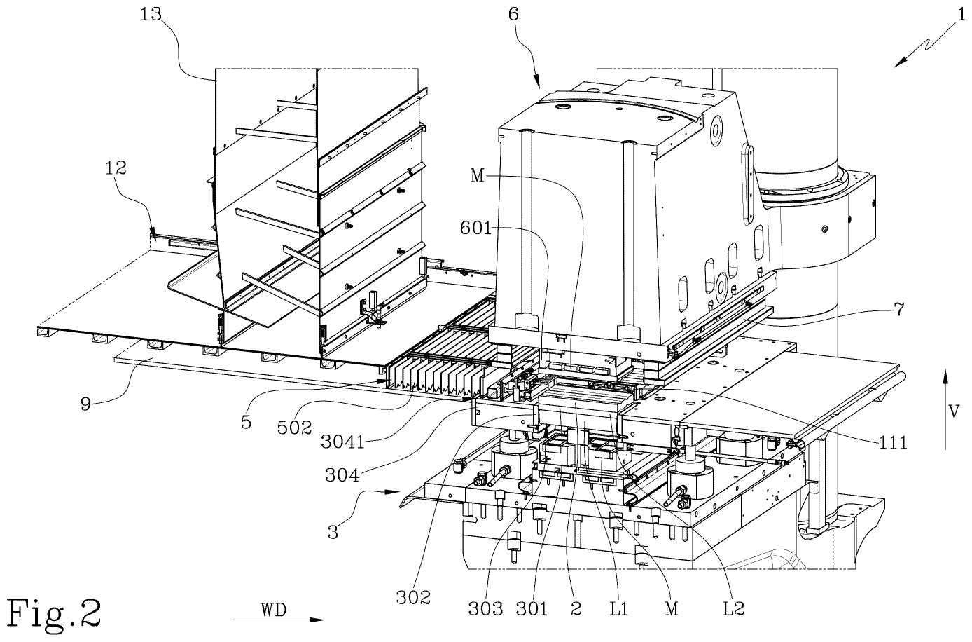

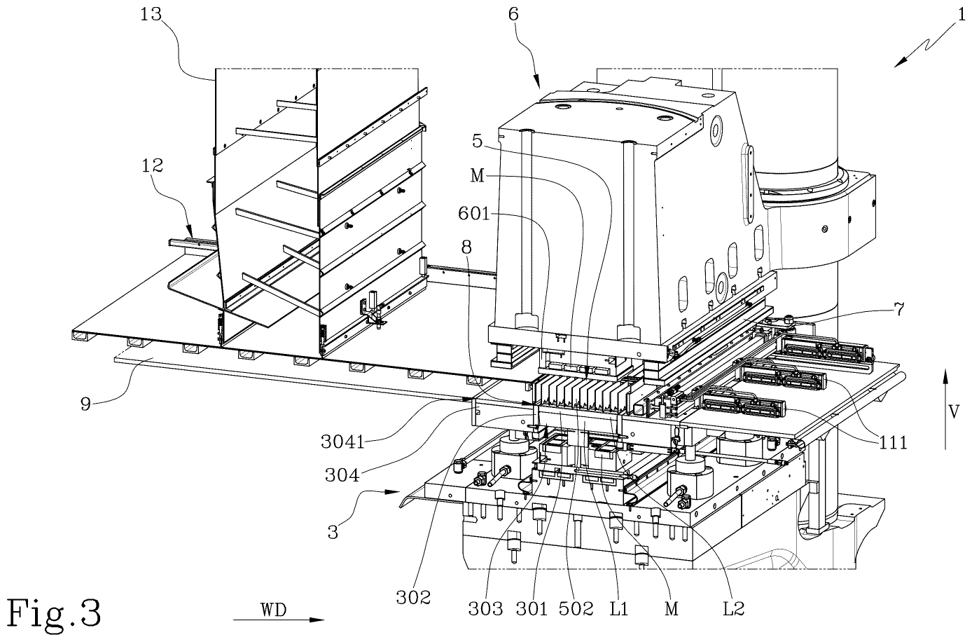

Thus, the carriage moves between different positions. In an initial position, the feeding device 5 is in the loading position. In this position, the passage 501 of the feeding device 5 is vertically aligned with the hopper to receive the charge. In this position, the pick-up device is located upstream of the moulding cavity 4. Also, in the initial position, the lower die and the upper die are in the pressing position. In the pressing position, the lower punch 303 is lowered to form the moulding cavity 4 and the upper punch is inserted into the moulding cavity and compresses the raw material. Thus, while one slab 2 is being formed in the moulding cavity 4, the feeding device 5 is in the loading position to receive the charge to be compressed to form the slab in the next cycle. When the slab is formed, the lower die and the upper die move to the open position (FIG. 1). In addition, the lower punch 303 moves upwards along the vertical direction V to bring the formed slab to the height of the feeding surface 9. In an example, the lateral wall 302 moves downwards in the delivery position of the pick-up device. More specifically, the downward movement of the lateral wall occurs at the same time as the upward movement of the bottom wall. In this position, the carriage moves forward in the working direction WD and the pick-up device is in the pick-up position (FIG. 2). With the movement of the carriage 12 along the working direction, the powdery raw material is transported along the feeding surface 9 towards the moulding cavity 4. Next, the carriage moves forward in the working direction. The slab grabbed by the pick-up device 11 is moved towards the outlet. When the pick-up device is at the outlet O, the feeding device 5 is in the unloading position. In this position, the lower punch 303 and the top surface 3041 are in the alignment position and the passage 501 of the feeding device 5 is vertically aligned with the bottom wall 301. In an example, after unloading the charge to the bottom wall, the carriage 12 moves forward in the working direction WD. In this position, both the feeding device and the pick-up device are at the outlet (FIG. 3). In this position, the dies are still in the open position. The carriage then moves backwards to return to the initial position. When the carriage 12 moves back along the working direction, the dies are still in the open position and the feeding device 5 skims the powdery raw material inside the moulding cavity.

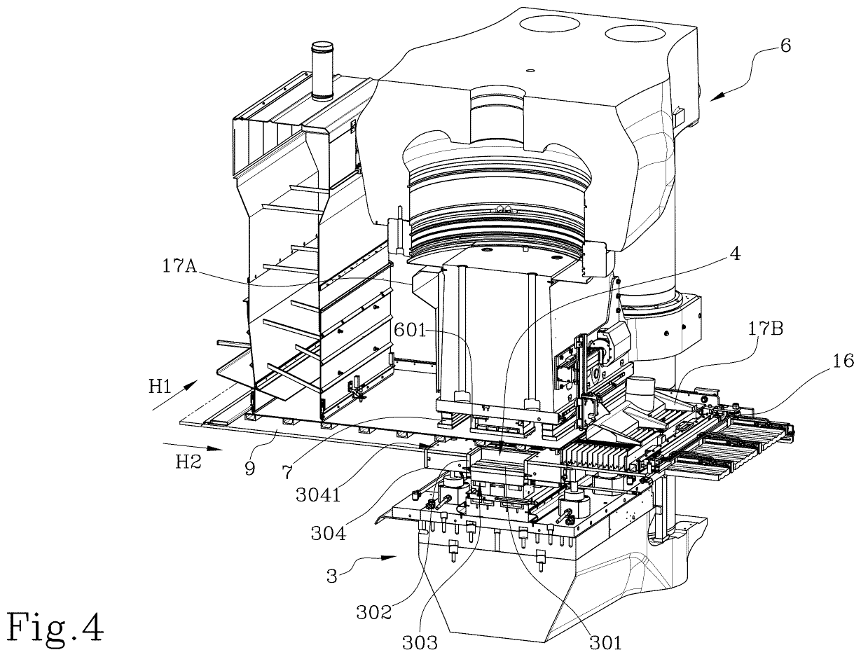

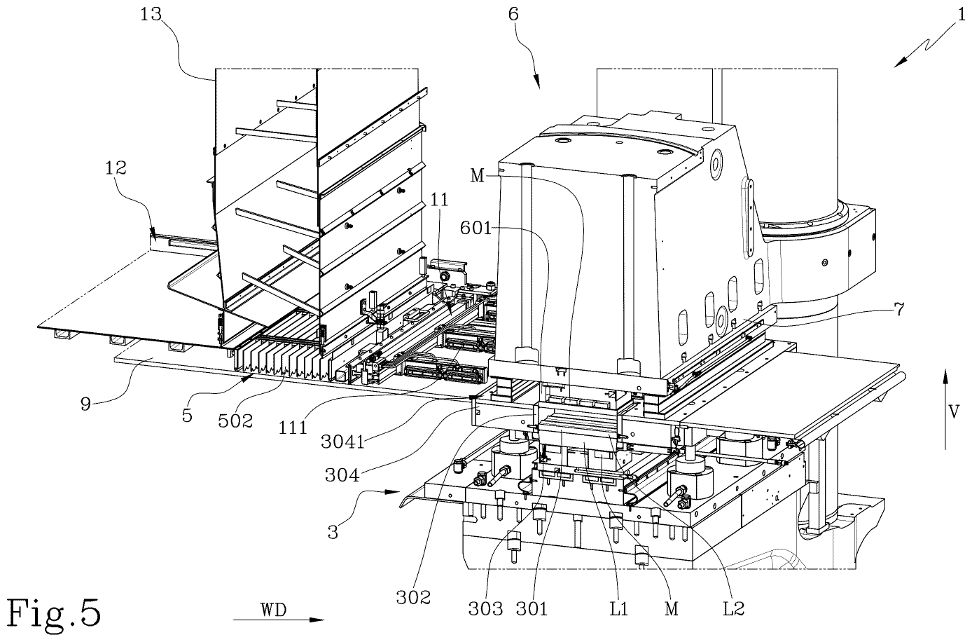

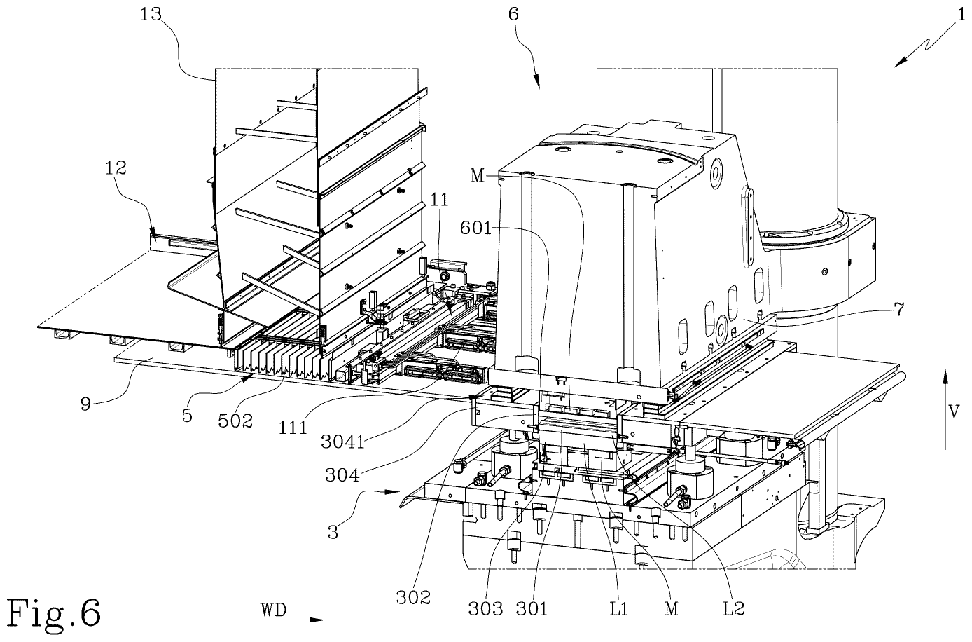

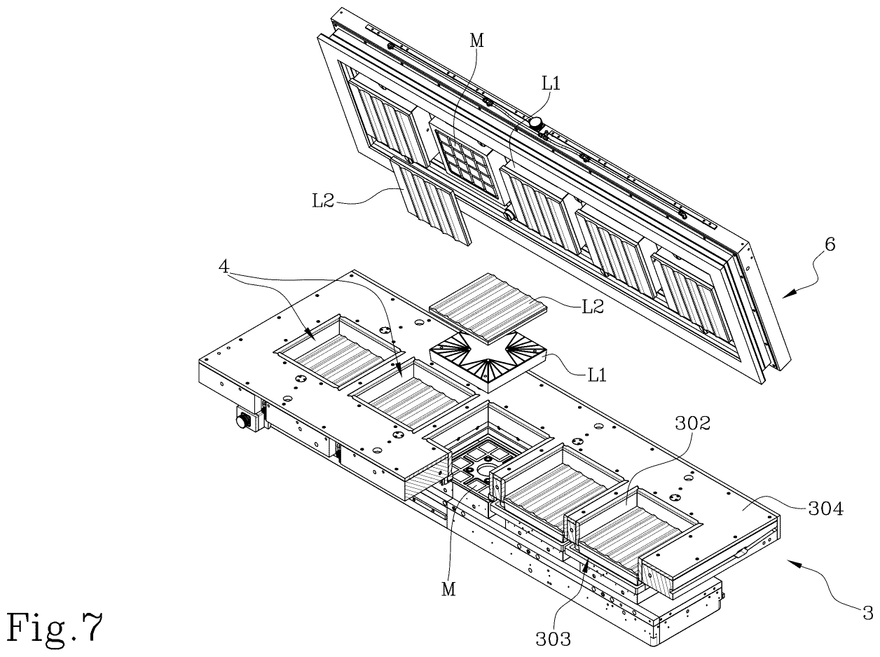

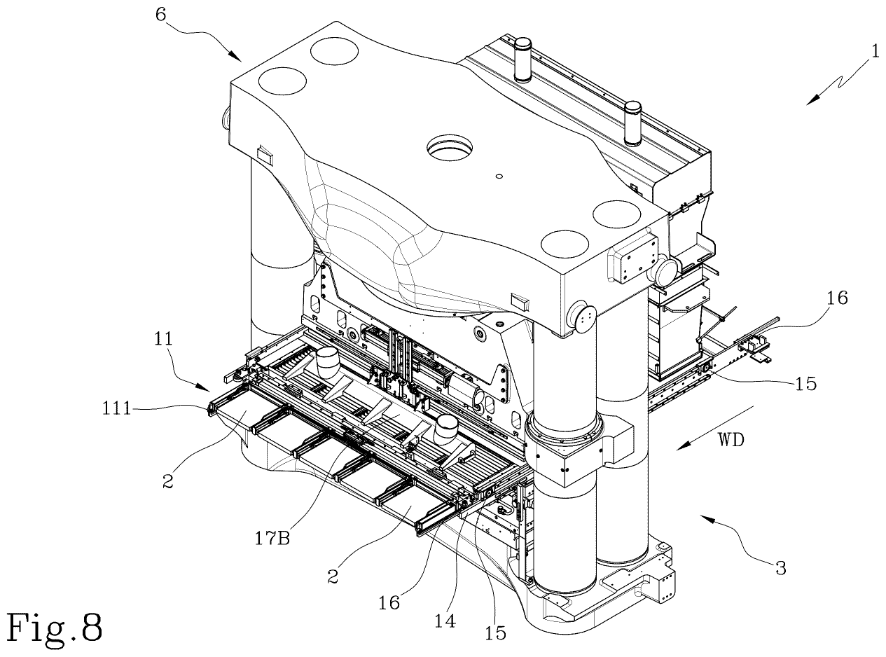

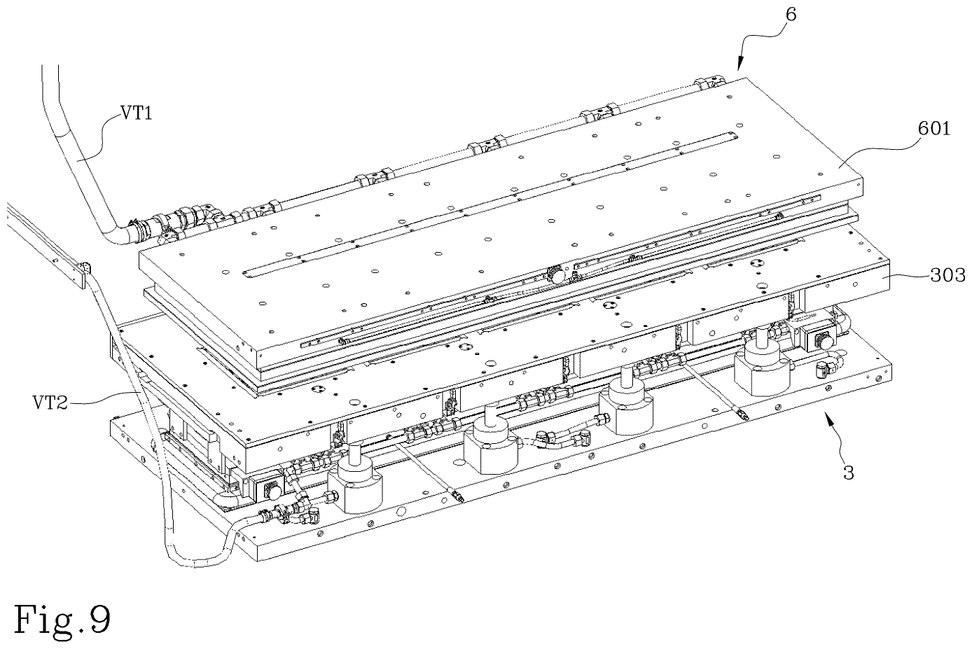

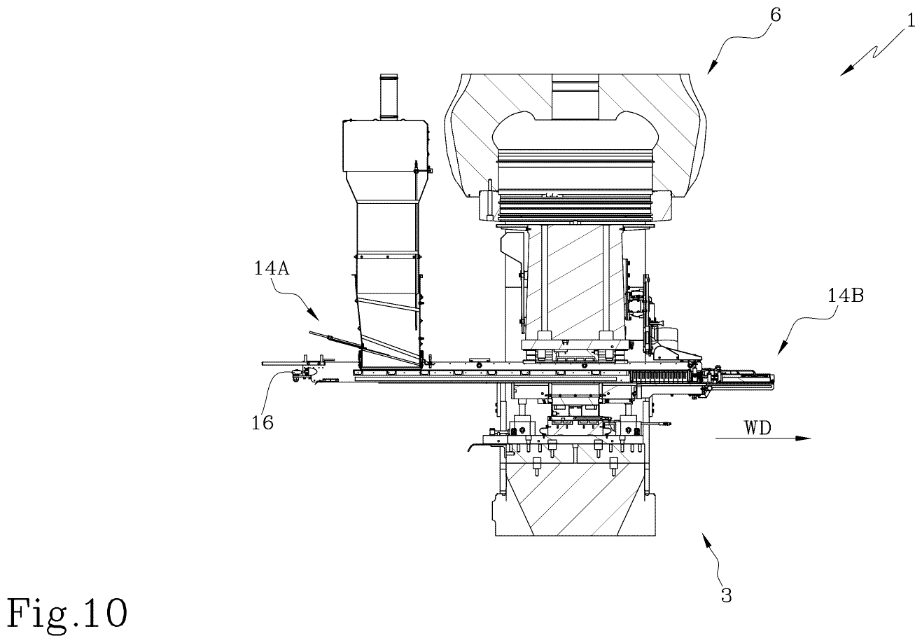

At this moment, the lower die and the upper die move to the pre-pressing position (FIG. 4). In an example, in this position, the vacuum system is activated. As the carriage moves back, the feeding device 5 skims the charge. Next, the dies move to the pressing position to form the slab (FIG. 5).

The apparatus comprises a particle suction system. The particle suction system removes airborne particles. More specifically, the particle suction system has a first hood 17A and a second hood 17B. The first hood and the second hood are connected to the upper die 6. The first hood is placed upstream of the moulding cavity 4 in an advancing direction AD. The advancing direction AD is defined from the inlet I towards the outlet O. The first hood removes the airborne particles from the surroundings of the moulding cavity 4. The second hood is placed downstream of the moulding cavity 4 in the advancing direction. The second hood removes the airborne particles from the surroundings of the outlet. In an example, the second hood is movable vertically. The second hood may also be movable horizontally. In an example, the second hood is activated when the dies are in the pressing position.

In an example, the apparatus includes a heating system. The heating system is connected to the lower die 3. The heating system is also connected to the upper die. The heating system keeps the dies at a predetermined temperature. The heating system may be a resistance heating system.

1. An apparatus for manufacturing slabs from powdery raw material, the apparatus comprising:
a lower die, defining a moulding cavity;
a feeding device, configured to receive a charge of the powdery raw material and to feed the charge of the powdery raw material to the moulding cavity;
an upper die, provided with an upper punch and movable relative to the lower die along a vertical direction, between an open position, where the upper punch is spaced from the lower die to allow loading the charge into the moulding cavity, and a pressing position, where the upper punch is inserted into the moulding cavity to compress the charge to form the slab, wherein the upper die and the lower die are also displaceable to a pre-pressing position, vertically interposed between the open position and the pressing position, wherein, in the pre-pressing position, the moulding cavity is closed by the upper punch to prevent the charge from moving out of the moulding cavity but, at the same, it is in air communication with a surrounding air volume;
a sealing arrangement configured to keep the moulding cavity and said surrounding air volume airtight, in the pre-pressing and pressing positions of the upper die and the lower die;
a vacuum system, configured to suck air from the moulding cavity in the pre-pressing position of the upper die and the lower die, and to keep a negative pressure inside the moulding cavity in the pressing position of the upper die and the lower die.

2. The apparatus according to claim 1, wherein the lower die includes a bottom wall and a lateral wall cooperating with the bottom wall to delimit the moulding cavity, the bottom wall and the lateral wall being movable relative to one another along the vertical direction

3. The apparatus according to claim 2, wherein the lower die includes a lower punch defining the bottom wall and a lower block defining the lateral wall and having a top surface which extends along a horizontal plane perpendicular to the vertical direction, wherein the lower punch and the lower block are movable along the vertical direction relative to each other to be displaceable between an alignment position, where the bottom wall is flush with the top surface so that the bottom wall and the top surface lie in the same feeding plane, and an offset position, where the bottom wall is placed below the top surface so as to define the moulding cavity.

4. The apparatus according to claim 3, comprising a feeding surface which extends along the feeding plane, wherein the feeding device defines a passage oriented vertically and is movable in a working direction parallel to the feeding surface, in sliding contact with the feeding surface between a loading position, where the feeding device receives the charge of powdery raw material, and an unloading position, where the passage is vertically aligned with the bottom wall so that, in the unloading position, the charge is contained in a volume delimited by the passage and the bottom wall.

5. The apparatus according to claim 4, further comprising:
an outlet, wherein the formed slabs are provided at the outlet;
a pick-up device, movable along the working direction (W/D), between a pick-up position, where the pick-up device grabs the formed slab, and a delivery position, where the pick-up device delivers the slab to the outlet

6. The apparatus according to claim 5, comprising a carriage, configured to move backwards and forwards along the working direction, wherein the pick-up device and the feeding device are connected to the carriage wherein the pick-up device is positioned upstream of the feeding device in the forward direction defined from the loading position towards the outlet, and wherein, in the pick-up position of the pick-up device, the feeding device is placed in the loading position, and, in the delivery position of the pick-up device, the feeding device is placed in the unloading position.

7. The apparatus according to claim 5, wherein in the pick-up position of the pick-up device, the bottom wall is configured to be moved upwards along the vertical direction and the lateral wall is configured to be displaced downwards along the vertical axis.

8. The apparatus according to claim 6, further comprising:
a pair of sliding bars extending longitudinally and spaced from each other along a first horizontal axis, each sliding bar having a first end and a second end, the first horizontal axis being orthogonal to a second horizontal axis along the working direction, wherein the carriage is configured to slide on the sliding bars backwards and forwards and along the working direction;
a plurality of longitudinal wheels distributed on each bar of the sliding bars along the working direction and configured to support the weight of the carriage along the sliding bars and to allow the carriage to move backwards and forwards along the working direction;
a plurality of transversal wheels placed at two ends of each sliding bar and arranged rotated by 90 degrees with respect to the longitudinal wheels, to keep the carriage aligned with the working direction along which it moves, wherein the longitudinal and transversal wheels are made from rubber.

9. The apparatus according to claim 2, wherein the bottom wall is movable vertically with respect to the lateral wall.

10. The apparatus according to claim 1, having an inlet to receive the powdery raw material and an outlet, to receive the formed slabs, the apparatus further comprising a particle suction system, configured to remove airborne particles, the particle suction system having a first hood and a second hood, connected to the upper die, wherein the first hood is placed upstream of the moulding cavity in an advancing direction defined from the inlet towards the outlet and is configured to remove the airborne particles from the surroundings of moulding cavity and wherein the second hood is placed downstream of the moulding cavity in the advancing direction and is configured to remove the airborne particles from the surroundings of the outlet.

11. The apparatus according to claim 1, wherein the lower die includes a plurality of moulding cavities arranged to form an array of moulding cavities, and wherein the upper die includes a plurality of upper punches each upper punch being configured to cooperate with a corresponding moulding cavity to form a respective slab of a plurality of slabs.

12. The apparatus according to claim 1, comprising a heating system, connected to the lower die and to the upper die to keep them at a predetermined temperature.

13. The apparatus according to claim 1, wherein the lower die includes a bottom wall and a lateral wall cooperating with the bottom wall to delimit the moulding cavity, wherein the bottom wall the lateral wall and the upper punch are made from stainless steel.

14. The apparatus according to claim 12, wherein the upper punch and the lower punch has a first layer and a second layer removably connected to the first layer, the second layer being in contact with the powdery raw material, wherein the second layer of the upper punch and of the lower punch is made from stainless steel.

15. A method for manufacturing slabs from powdery raw material, the method comprising the following steps:
providing a lower die, defining a moulding cavity
providing an upper die with an upper punch
moving the upper die and the lower die relative to one another, along a vertical direction, between an open position and a pressing position, to compress a charge of the powdery raw material to form the slab;
feeding the charge of the powdery raw material to the moulding cavity through a feeding device when the upper die and the lower die are in the open position;
displacing the upper die and the lower die in a configuration intermediate between the open position and the pressing position, so that the upper die and the lower die are in a pre-pressing position, wherein, in the pre-pressing position, the moulding cavity is closed by the upper punch to prevent the charge from moving out of the moulding cavity but, at the same time, it is in air communication with a surrounding air volume;
keeping the moulding cavity and said surrounding air volume airtight, when the upper die is in the pre-pressing position and in the pressing position;
sucking air from the moulding cavity, when the upper die and the lower die are in the pre-pressing position, and keeping a negative pressure inside the moulding cavity while pressing the

16. The method according to claim 15, comprising the following steps:
providing the lower die with a bottom wall and a lateral wall cooperating with the bottom wall to delimit the moulding cavity
moving the bottom wall and the lateral wall relative to one another, along the vertical direction;
providing the lower die with a lower punch defining the bottom wall and with a lower block, defining the lateral wall and having a top surface which extends along a horizontal plane perpendicular to the vertical direction wherein, the lateral wall cooperates with the bottom wall to delimit the moulding cavity;
moving the lower punch and the lower block along the vertical direction relative to each other between an alignment position, where the bottom wall is flush with the top surface so that the bottom wall and the top surface lie in the same feeding plane, and an offset position, where the bottom wall is placed below the top surface so as to define the moulding cavity,
moving the bottom wall vertically with respect to the lateral wall.

17. The method according to claim 16, comprising the following steps:
providing the feeding device with a passage oriented vertically;
moving the feeding device into sliding contact with a feeding surface and in a working direction parallel to the feeding surface between a loading position and an unloading position, wherein the feeding surface extends along the feeding plane;
loading the feeding device with the charge in the loading position;
vertically aligning the passage with the bottom wall in the unloading position, so that, in the unloading position, the charge is contained in a volume delimited by the passage and the bottom wall.

18. The method according to claim 17, comprising the following steps:
providing a pick-up device
moving the pick-up device along the working direction between a pick-up position and a delivery position;
grabbing the formed slab through the pick-up device in the pick-up position;
providing the slab through the pick-up device to an outlet in the delivery position;
connecting the pick-up device and the feeding device to a carriage;
moving the carriage backwards and forwards along the working direction;
placing the pick-up device upstream of the feeding device in the forward direction defined from the loading position towards the outlet;
placing the feeding device in the loading position when the pick-up device is in the pick-up position;
placing the feeding device in the unloading position when the pick-up device is in the unloading position.

19. The method according to claim 15, wherein, the step of sucking air from the molding cavity begins when the upper die and the lower die are in the pre-pressing position, and continues during the movement of the upper die downwards along the vertical direction between the pre-pressing position to a position where the upper punch is in contact with the powder inside the cavity.

20. The method according to claim 15 wherein suction channels are provided in the lower die and in the upper die for sucking air from the molding cavity, so that air is sucked both from above and below the moulding cavity.

21. An apparatus for manufacturing slabs from powdery raw material, the apparatus comprising:
a lower die, defining a moulding cavity;
a feeding device, configured to receive a charge of the powdery raw material and to feed the charge of the powdery raw material to the moulding cavity;
an upper die, provided with an upper punch and movable relative to the lower die along a vertical direction, between an open position, where the upper punch is spaced from the lower die to allow loading the charge into the moulding cavity, and a pressing position, where the upper punch is inserted into the moulding cavity to compress the charge to form the slab, wherein the upper die and the lower die are also displaceable to a pre-pressing position, vertically interposed between the open position and the pressing position, wherein, in the pre-pressing position, the moulding cavity is closed by the upper punch to prevent the charge from moving out of the moulding cavity but, at the same, it is in air communication with a surrounding air volume;
a sealing arrangement configured to keep the moulding cavity and said surrounding air volume airtight, in the pre-pressing and pressing positions of the upper die and the lower die; the apparatus having an inlet to receive the powdery raw material and an outlet, to receive the formed slabs, the apparatus further comprising a particle suction system, configured to remove airborne particles, the particle suction system having a first hood and a second hood, connected to the upper die, wherein the first hood is placed upstream of the moulding cavity in an advancing direction defined from the inlet towards the outlet and is configured to remove the airborne particles from the surroundings of moulding cavity and wherein the second hood is placed downstream of the moulding cavity in the advancing direction and is configured to remove the airborne particles from the surroundings of the outlet.
